(19) United States
(12) Patent Application Publication
(10) Pub. No.: US 2025/0132364 A1
(43) Pub. Date: Apr. 24, 2025

(54) CARBON CAPTURE SYSTEM ONBOARD A VESSEL

(71) Applicants: TOTALENERGIES ONETECH, Courbevoie (FR); POLITECNICO DI MILANO, Milano (IT); UNIVERSITEIT UTRECHT HOLDING B.V., Utrecht (NL)

(72) Inventors: Luis Manuel Cravo Pereira, Santiago do Cacém (PT); Maxime Lacroix, Sainte-Adresse (FR); Matteo Gazzani, Utrecht (NL); Lukas Weimann, Utrecht (NL); Matteo Carmelo Romano, Piacenza (IT)

(21) Appl. No.: 18/832,121

(22) PCT Filed: Jan. 23, 2023
(86) PCT No.: PCT/EP2023/051507

§ 371 Date: Jul. 23, 2024

(30) Foreign Application Priority Data
Jan. 25, 2022 (EP) 22153143.7

(51) Int. Cl. H01M 8/0668; B01D 53/22; B63J 4/00; H01M 8/0662; H01M 8/14

(52) U.S. Cl. CPC H01M 8/0668; B01D 53/229; B63J 4/00; H01M 8/0687; H01M 8/145; B01D 2256/16; B01D 2257/504; B01D 2258/01; B01D 2259/4566; H01M 2008/147

(57) ABSTRACT

Subject of the invention is a carbon capture system onboard a vessel which comprises an internal combustion engine for producing power and an exhaust gas, a molten carbonate fuel cell, which comprises a cathode and an anode, for producing electric energy, a cathode outlet stream and an anode outlet stream, wherein the cathode is in fluid communication with the internal combustion engine for receiving at least a portion of the exhaust gas, and a CO₂ separation means which is in fluid communication with the anode for receiving at least a portion of the anode outlet stream, wherein the CO₂ separation means is configured to separate CO₂ from the at least a portion of the anode outlet stream for producing a CO₂ rich stream and a CO₂ depleted stream wherein the molten carbonate fuel cell has an electric connection with the CO₂ separation means for at least partially using the electric energy to at least partially operate the CO₂ separation means.

### FIELD OF THE INVENTION

The invention relates to carbon capture systems onboard vessels and to respective vessels, and further relates to corresponding uses and methods, wherein carbon capture is in particular carbon dioxide (CO₂) capture.

### BACKGROUND OF THE INVENTION

According to the International Maritime Organization (IMO), in 2018 greenhouse gas emissions from international shipping were around 1 GtCO₂ eq., representing approximately 3% of all global CO₂ emissions. Further projections from the IMO for business-as-usual scenarios show that compared to current levels greenhouse gas emissions from ships could increase by 50% up to 250% until 2050. Thus, during an IMO strategy meeting in April 2018 an initial strategy was formed to reduce the total amount of annual greenhouse gases until 2050 by 50% in comparison to the emissions in 2008. In view of the factual CO₂ emissions from ships the set goal is ambitious. Actually, conventional marine fuels emit varying amounts of CO₂ when burned, with a CO₂ intensity of the fuel (tCO₂/tfuel) ranging between 2.75 for liquified natural gas (LNG) and 3.2 for diesel/marine gasoil.

In view of these high emissions, various routes to reduce CO₂ emissions from ships have been contemplated, including the use of electric ships, of fuel cells running on so-called blue/green hydrogen or ammonia, and of internal combustion engines (ICEs) running on hydrogen, methanol, ammonia or biofuels. However, those routes are accompanied by a number of difficulties. Batteries required for electric motors of electric ships are regularly very costly and have low energy density, which renders electric ships often non-competitive, in particular with regard to medium to long range voyages. Blue/green hydrogen, methanol, ammonia and biofuels are regularly also quite costly, and they are furthermore often not available in sufficient quantities, or sometimes not even available at all. Furthermore, internal combustion and bunkering systems first need to be adapted to such fuels, leading to additional expenditures.

Thus, technical solutions to prevent emissions of CO₂ stemming from conventional fuels on board of a vessel have been investigated as well. In particular, the capture of CO₂ and a subsequent storage thereof on board of ships has been considered as a transition solution to lower the CO₂ emissions from the maritime industry in the short term, giving the necessary time for zero-emission technologies to be fully developed and implemented.

For example, Luo et al. (Applied Energy 195 (2017) 402-413) describe how to apply a solvent-based post-combustion carbon capture process to capture CO₂ from the energy system in a typical cargo ship. They found that that the carbon capture level could only reach 73% when the existing ship energy system is integrated with the CO₂ capture process due to limited heat and electricity supply onboard the ship. Freenstra et al. (International Journal of Greenhouse Gas Control 85 (2019) 1-10) present a technical and economic evaluation for ship-based carbon capture on diesel or LNG-fuelled vessels using solvent-based technologies. Lee et al. (International Journal of Greenhouse Gas Control 105 (2021) 103241) describe the utilization of a solvent technology that selectively captures and stores CO₂ contained in exhaust gas emitted from an internal combustion engines of a ship. US 2016/0369674 A1 describes a process in which at least a portion of CO₂ produced by an internal combustion of a vehicle is captured in a liquid sorbent onboard the vehicle, followed by recovering the CO₂ from the sorbent and compressing the CO₂ for temporary storage onboard the vehicle.

However, all the above-described strategies based on solvent-based CO₂ capture systems require both thermal energy for solvent regeneration and electrical energy for CO₂ compression, and the availability of such energies onboard ships is normally rather limited. Further, the suggested strategies regularly require the use of amines as solvents for absorbing CO₂. However, amines easily undergo thermal- and oxidative-degradation, thereby forming hazardous compounds like nitrosamines, nitramines, and amides. Already at very low concentrations such compounds are toxic and carcinogenic for humans (see for example A. Rusin et al., Pol. J. Environ. Stud. Vol. 25, No. 3 (2016), 909-916). While this can be managed, yet expensive, for onshore applications, it would be particularly challenging for onboard applications.

Accordingly, solvent-free approaches to CO₂ treatment and capture onboard vessels would be desirable. Baccioli et al. (Applied Energy 298 (2021) 117192) study a hybrid ship propulsion system combining an internal combustion engine and a molten carbonate fuel cell, wherein an exhaust gas from the internal combustion engine is used as a CO₂ source for fuel cell operation. However, CO₂ leaving the fuel cell at its anode is recirculated partially to an inlet of the anode and partially to an engine inlet without any capture thereof. Baccioli et al. are therefore not contributing to the desired capturing and subsequent storing of CO₂ onboard a vessel.

The use of molten carbonate fuel cells is also addressed in US 2017/0271701 A1 with a view to increased fuel utilization and/or increased CO₂ utilization. Therein, it is contemplated to perform an effective amount of an endothermic reaction within a fuel cell stack in an integrated manner. This shall allow for a desired temperature differential to be maintained within the fuel cell. However, the use of a molten carbonate fuel cell for treating exhaust gas from a combustion engine onboard a vessel is not explicitly addressed. Further, no specific utilization of electricity generated onboard a vessel by a molten carbonate fuel cell is described.

A vessel equipped with a fuel cell system is also described in KR 20140064224 A. Here, exhaust gas comes from a main engine and is fed to the cathode of a molten carbonate fuel cell. A utilization of the electricity generated by the fuel cell is not described. Moreover, the outlet stream from the anode of the fuel cell is sent to a CO₂ capture facility without any further processing thereof. The anode outlet stream will thus naturally contain significant amounts of other gaseous components, thereby lowering the concentration of the captured CO₂, and making its storage (onboard and later underground) hardly viable. Additionally, valuable further gaseous components are trapped in the capture facility and are thus lost for any further usage thereof.

Overall, there remains a general desire for an improved carbon capture system onboard a vessel.

### Problem Underlying the Invention

It is an object of the present invention to provide a carbon capture system onboard a vessel which at least partially overcomes the drawbacks encountered in the art.

It is in particular an object of the present invention to provide a carbon capture system onboard a vessel which captures highly concentrated CO₂, thereby preventing a pollution of the environment by that CO₂, and/or which allows to utilize gases different from CO₂ onboard a vessel.

It is furthermore an object of the present invention to provide a carbon capture system onboard a vessel which is at least partially a self-supporting system and/or which is more economic.

It is additionally an object of the present invention to provide a carbon capture system onboard a vessel which can make the vessel more autonomous, especially when at sea.

It is moreover an object of the present invention to provide a carbon capture system onboard a vessel which improves the combustion properties of an internal combustion engine, and/or which reduces methane slip of an internal combustion engine.

It is also an object of the present invention to provide a vessel which at least partially overcomes the drawbacks encountered in the art.

It is also an object of the present invention to provide uses which at least partially overcome the drawbacks encountered in the art.

It is also an object of the present invention to provide a method of capturing CO₂ onboard a vessel which at least partially overcomes the drawbacks encountered in the art.

It is also an object of the present invention to provide CO₂ which at least partially overcomes the drawbacks encountered in the art.

### DISCLOSURE OF THE INVENTION

Surprisingly, it has been found that the problem underlying the invention is overcome by carbon capture systems, vessels, uses, methods and CO₂ according to the claims. Further embodiments of the invention are outlined throughout the description.

Subject of the invention is a carbon capture system onboard a vessel, comprising:
an internal combustion engine for producing power and an exhaust gas,
a molten carbonate fuel cell, which comprises a cathode and an anode, for producing electric energy, a cathode outlet stream and an anode outlet stream, wherein the cathode is in fluid communication with the internal combustion engine for receiving at least a portion of the exhaust gas, and
a CO₂ separation means which is in fluid communication with the anode for receiving at least a portion of the anode outlet stream, wherein the CO₂ separation means is configured to separate CO₂ from the at least a portion of the anode outlet stream for producing a CO₂ rich stream and a CO₂ depleted stream
wherein the molten carbonate fuel cell has an electric connection with the CO₂ separation means for at least partially using the electric energy to at least partially operate the CO₂ separation means.

A vessel according to the present invention is a vessel within the meaning of Article 5ter Paris Convention for the Protection of Industrial Property (PC). Such a vessel is generally a watercraft and is in particular a ship, a yacht, a freighter, a containership, a gas tanker, an oil tanker, offshore platform or the like. The vessel according to the present invention does preferably not comprise any Fischer-Tropsch (FT) equipment, for example it does not comprise a Fischer-Tropsch reactor and/or it does not comprise a Fischer-Tropsch catalyst. The vessel according to the present invention does preferably not comprise any methanol synthesis equipment, for example it does not comprise a methanol synthesis reactor and/or it does not comprise a methanol synthesis catalyst. The vessel according to the present invention does preferably not comprise any nitrogen-containing compound synthesis equipment, for example it does not comprise a nitrogen-containing compound synthesis reactor and/or it does not comprise a nitrogen-containing compound synthesis catalyst, wherein the nitrogen-containing compound can in particular be ammonia.

As used herein, onboard a vessel means that the carbon capture system is located on a vessel within the meaning of Article 5ter PC. Thus, subject matter of the present invention is also a vessel (within the meaning of Article 5ter PC) which comprises a carbon capture system according to the present invention.

An internal combustion engine according to the present invention is a heat engine in which a combustion that generates heat takes place inside an engine proper (instead of in a furnace). The internal combustion engine according to the present invention thus includes, but is not limited to, a volumetric engine, for example a piston-cylinder engine. The internal combustion engine can for example be a Diesel engine or an Otto engine. The internal combustion engine can also be a gas turbine. The internal combustion engine will regularly be configured to run on, and will hence regularly be fed with, conventional fuels like natural gas, in particular LNG, diesel gasoil or other marine gasoil. However, different fuels like bio-fuels also form a possible fuel for the internal combustion engine.

A fluid communication according to the present invention allows an active or passive transfer of a fluid from a first physical device (e.g., engines, fuel cells, means, units, etc.) of the carbon capture system to a second physical device (e.g., engines, fuel cells, means, units, etc.) of the carbon capture system. An active transfer can for example be achieved using one or more pumps, compressors, blowers and/or fans. A passive transfer can for example be achieved using gravity. As used herein, a fluid is composed of either gaseous components, or of liquid components, or of a mixture of gaseous and liquid components. The communication between the first and the second physical device of the carbon capture system can for example be achieved using one or more pipes, tubes, hoses, etc., which connect the first and the second physical device of the carbon capture system. The communication itself does not qualify as a physical device within the meaning of the present invention, and the communication does especially not have an active influence on a fluid transferred therewith. A third and further physical devices may be arranged between the first physical device and the second physical device, provided fluid can still be transferred from the first physical device to the second physical device.

A molten carbonate fuel cell (MCFC) according to the present invention comprises a cathode and an anode as fuel cell electrodes. These electrodes are typically made of metal, in particular nickel. Between the electrodes, the MCFC further comprises an electrolyte which comprises at least one carbonate. The electrolyte preferably comprises a blend of alkali metal carbonates, more preferably a blend of lithium carbonate (Li₂CO₃) and potassium carbonate (K₂CO₃). An MCFC is suitable for distributed power generation with high efficiency conversion of energy, flexible operation and combined heat and power (CHP) production. MCFCs are already commercially available in medium-to large scale power generation (see for example 2014 PhD thesis “Applications for Molten Carbonate Fuel Cells” by Ivan Rexed).

At ambient temperature (e.g., around 25° C.), the carbonate(s) in the MCFC is/are solid. The MCFC is regularly operated at temperatures above ambient, typically within a preferred temperature range of 580° C. to 675° C. At such temperatures, the contained carbonate(s) is/are molten, leading to the term “molten carbonate fuel cell”. The MCFC produces electric energy (generates electricity). That is, the MCFC is configured to run in electricity production mode and/or is configured to not run in electrolysis mode. The electric energy produced by the MCFC can be advantageously used onboard the vessel and in particular for at least partially operating one or more devices (e.g., engines, fuel cells, means, units, etc.) of the carbon capture system, as further exemplified herein. The electric energy produced by the MCFC can also be used for propelling the vessel, i.e., it can at least partially be used for operating one or more propulsion means of the vessel. For this, the MCFC has an electric connection with one or more propulsion means of the vessel.

The electric energy is generally produced by the MCFC according to the following scheme:

O₂ and CO₂, which are regularly contained in the exhaust gas of an internal combustion engine, are reduced at the cathode into carbonate ions (CO₃²⁻) following the reaction:

½O₂+CO₂+2e−=CO₃²⁻

The carbonate ions CO₃²⁻ are transferred through the electrolyte to the anode. The operating temperature is regularly sufficiently high for reforming hydrocarbon fuels, for example methane, to hydrogen, in particular by steam reforming. The (steam) reforming is regularly carried out over a supported Ni-catalyst and may be performed by external or internal reforming (with respect to the MCFC). In case of the former, the fuel is converted to hydrogen and CO₂ before entering the fuel cell. In case of the latter, the (steam) reforming and usually an associated water-gas shift (WGS) reaction take place directly at the anode. Taking methane as a representative fuel, the reforming and WGS reactions are:

Steam reforming: CH₄+H₂O=3H₂+CO

WGS reaction: CO+H₂O=H₂+CO₂

The produced H₂ and CO will react with the carbonate ions (CO₃²⁻) according to the following reactions:

H₂+CO₃²⁻═CO₂+H₂O+2e−

CO+CO₃²⁻=2CO₂+2e−

It is seen that CO₂ is effectively separated from the exhaust gas and is transferred, or pumped, from the cathode to the anode of the MCFC. As a result, the outlet stream leaving the anode (the anode outlet stream) has an increased CO₂ concentration. The MCFC therefore acts as an effective CO₂ capture unit. Apart from CO₂, the anode outlet stream can contain further gases, in particular hydrogen (H₂) and/or carbon monoxide (CO). Additionally, the anode outlet stream may further contain water (H₂O) and/or unreacted components of the reformable fuel, especially methane (CH₄). As used herein, the term “stream” refers to a fluid as defined hereinbefore. The anode outlet stream regularly comprises gaseous components and may in some cases consist of gaseous components. As such, the anode outlet stream stream is preferably an at least partially gaseous stream and is more preferably a completely gaseous stream.

Downstream the anode of the molten carbonate fuel cell, a CO₂ separation means is provided. The anode outlet stream is received by the CO₂ separation means (as an inlet stream) and is separated by the CO₂ separation means into a CO₂ rich stream and a CO₂ depleted stream. The CO₂ separation means is thus configured to, i.e., is technically able to, separate CO₂ from other components of the anode outlet stream. The CO₂ separation means is preferably an amine-free CO₂ separation means and is more preferably a solvent-free separation means.

By separating CO₂ from the anode outlet stream, the CO₂ separation means produces at least two outlet streams, namely a first stream having a higher CO₂ concentration (the CO₂ rich stream), and a second stream having a lower CO₂ concentration (the CO₂ depleted stream). The CO₂ concentration of the CO₂ rich stream is thus higher that the CO₂ concentration of the CO₂ depleted stream. Herein, concentration refers to concentration in mol %.

By producing the CO₂ rich stream, the CO₂ separation means acts as an effective CO₂ capture unit and further purifies the CO₂ captured with the carbon capture system according to the invention. The CO₂ rich stream is preferably an at least partially liquid stream and is more preferably a completely liquid stream. The CO₂ rich stream can be sent to storage means, like one or more containers, so that highly concentrated CO₂ is captured and subsequently stored onboard the vessel. For this, the CO₂ separation means is in fluid combination with the one or more containers. CO₂ captured and stored onboard the vessel can later be stored or utilized onshore. Additionally, or alternatively, CO₂ contained in the CO₂ rich stream can be further utilized onboard the vessel. For example, the CO₂ rich stream can be sent to a cathode of a second, auxiliary molten carbonate fuel cell onboard the vessel for further production of electric energy. Another example could be chemical conversion of CO₂ rich stream to valuable products such as methanol (see for example B. Lima et al., Comput. Aided Chem. Eng. Vol. 37, (2015), 1385-1390).

The CO₂ depleted stream is preferably an at least partially gaseous stream and is more preferably a completely gaseous stream. The CO₂ depleted stream regularly contains gases different from CO₂, in particular H₂ and CO. Such gases can be recirculated within the system, for example to the internal combustion engine or to the MCFC, in particular to the anode of the MCFC. Recirculation to the anode of the MCFC is preferably achieved by means of an additional (or second) fluid communication established between the CO₂ separation means and the anode of the MCFC. In this way, the CO₂ depleted stream is fed to the anode as an anode inlet stream. Accordingly, it is preferred that in the carbon capture system according to the present invention, the CO₂ separation means is in additional fluid communication with the anode for at least partially recycling the CO₂ depleted stream to the anode as an anode inlet stream. As the CO₂ depleted stream becomes an anode inlet stream, it is preferred that no internal combustion engine is arranged between the CO₂ separation means and the anode, more specifically between the CO₂ separation means and an inlet of the anode to which the CO₂ depleted stream is fed as an anode inlet stream. This anode inlet stream regularly contains unreacted components of the reformable fuel previously sent to the anode 7. The recycling thereof allows for a further utilization of these unreacted components as a fuel for the MCFC. As a result, the overall carbon capture system becomes more economic. Further, undesired emissions of the unreacted fuel components and of CO₂ to the vessel's environment and especially to the sea can be further reduced and potentially completely avoided. This helps to further improve the environmental footprint of the vessel. In order to further suppress undesired emissions of CO₂ to the vessel's environment and especially to the sea it is particularly preferred that the CO₂ separation means is a cryogenic distillation unit in which CO₂ is separated by distillation, or is a packed bed cryogenic unit in which CO₂ is separated by sublimation.

Additionally, or alternatively, H₂ contained in the CO₂ depleted stream can be sent to an auxiliary fuel cell onboard the vessel for further production of electric energy. Additionally, or alternatively, heat of the CO₂ depleted stream can be utilised onboard the vessel, for example for generating steam. The CO₂ depleted stream may also contain unreacted components of the reformable fuel sent to the anode of the MCFC, in particular unreacted CH₄. Such unreacted components like CH₄ can be recirculated within the system, in particular to the internal combustion engine, or to the anode of the MCFC as further described herein, for further utilisation of these unreacted components (or gases) within the system.

Overall, the carbon capture system according to the invention can capture highly concentrated CO₂ so that a pollution of the environment by that CO₂ is prevented. Simultaneously, the carbon capture system according to the invention can allow for an advantageous utilization of gases different from CO₂ onboard the vessel. Further, the present invention provides a carbon capture system onboard a vessel which improves the combustion properties of an internal combustion engine, and/or which reduces methane slip of an internal combustion engine. The carbon capture system according to the invention can hence in particular be an at least partially a self-supporting system. This is particularly advantageous for a vessel, which when at sea should be as autonomous as possible. The self-supporting characteristics of the carbon capture system according to the invention can advantageously contribute to the autonomy of the vessel.

It is preferred that the CO₂ separation means is selected from a membrane unit, a pressure swing adsorption unit and a low temperature phase change separation unit. It is more preferred that the CO₂ separation means is a low temperature phase change separation unit (see for example, Berstad et al., J. Int. Acad. Refrig. Vol. 36, No. 5 (2013), 1403-1416). In a low temperature phase change separation unit, CO₂ is condensed from the anode outlet stream, i.e., gaseous CO₂ is converted into liquid CO₂, to give a condensed fraction. The condensed fraction corresponds to the CO₂ rich stream. In this case, the CO₂ rich stream is at least initially a liquid stream. At the same time, additional components remain in the anode outlet stream, i.e., remain gaseous, to give an uncondensed fraction. The uncondensed fraction corresponds to the CO₂ depleted stream. In this case, the CO₂ depleted stream is a gaseous stream. With a low temperature phase change separation unit, CO₂ can be separated from the anode outlet stream in a particularly effective manner and can be captured in advantageously high concentrations. Accordingly, the prevention of a pollution of the environment by the captured CO₂ is particularly effective as well. Simultaneously, the concentrations of other gases different from CO₂ in the anode outlet stream can increase, so that these gases can be utilized onboard the vessel also in a particularly effective manner.

It is preferred that the CO₂ separation means is a low temperature separation unit which is additionally configured to utilize cold energy from the vaporization of liquified natural gas (LNG) fuel stored on board the vessel. Cold energy is transferred by means of direct heat exchange with LNG or indirectly by means of a refrigerant fluid (e.g., glycol-water mixture or ammonia), or any combination thereof. In such a low temperature phase change separation unit CO₂ is condensed from the anode outlet stream, i.e., gaseous CO₂ is converted into liquid CO₂, to give a condensed fraction. The condensed fraction corresponds to the CO₂ rich stream. In this case, the CO₂ rich stream is at least initially a liquid stream. At the same time, additional components remain in the anode outlet stream, i.e., remain gaseous, to give an uncondensed fraction. The uncondensed fraction corresponds to the CO₂ depleted stream. In this case, the CO₂ depleted stream is a gaseous stream.

It is preferred that the CO₂ separation means allows to produce a CO₂ rich stream which has a CO₂ purity of 95 mol % or more, more preferably of 96 mol % or more, still more preferably of 97 mol % or more, even more preferably of 98 mol % or more and most preferably of 99 mol % or more. With such a CO₂ separation means, a particularly effective carbon capture can be achieved.

The MCFC has an electric connection to the CO₂ separation means for at least partially using the electric energy produced by the MCFC to at least partially operate the CO₂ separation means. An electric connection between fuel cells, means and other devices (engines, units, etc.) implies that the respective fuel cells, means and other devices are electrically connected to each other so that electric energy can be exchanged between them. Logically, the electric connection also implies (or means) that two distinct (separate, different) entities are connected. Here, the MCFC and the CO₂ separation means are such distinct entities. In other words, the MCFC does not qualify as a CO₂ separation means within the meaning of the present invention. If required, a direct current produced by the MCFC can be converted into an alternating current using a current conversion means downstream of the MCFC. Herein, an electric connection is preferably established by wiring. By configuring the carbon capture system in this way, the electric energy produced by the MCFC can be advantageously used onboard the vessel itself, and CO₂ may be captured in a particularly effective manner. Moreover, by configuring the carbon capture system in this way, the need for further electricity input from the outside can be reduced and potentially fully removed. Accordingly, the carbon capture system can advantageously become an at least partially self-supporting system. This is particularly advantageous for a vessel, which when at sea should be as autonomous as possible. Here, the use of the electric energy produced by the MCFC to achieve the desired CO₂ capture adds to the autonomy of the vessel. Furthermore, the electric energy produced by the MCFC can partially be used as additional propulsion for the ship using electrical engines, for which the MCFC preferably has an electric connection to an electrical engine of the vessel. This can further reduce emissions and in particular CO₂ emissions, so that a vessel can be provided which can help to achieve the zero emission goals of the future.

It is preferred that the electric energy produced by the MCFC is partially stored in electricity storage means, more preferably in a primary or secondary battery. By partially storing the electric energy produced by the MCFC, the electric energy can be utilized in a highly variable manner, thereby enhancing the versatility of the carbon capture system. In a particularly preferred case, the electric energy stored in electricity storage means, in particular stored in a primary or secondary battery, is also used to partially operate the CO₂ separation means. In this case, the electricity storage means, in particular the primary or secondary battery, has an electric connection to the CO₂ separation means.

It is preferred that the CO₂ separation means is a low temperature separation unit which is additionally configured to separate water from the at least a portion of the anode outlet stream. Such a CO₂ separation means can thus produce a CO₂ rich stream, a CO₂ depleted stream and a water stream. The water stream is regularly a liquid water stream. The separate removal of water leads to less water in both, the CO₂ rich stream and the CO₂ depleted stream. This can improve the concentration of the captured and then either stored or reused CO₂ rich stream, and/or can improve the purity of valuable gases in the CO₂ depleted stream, in particular of H₂ and CO, and can hence improve the further utilization of these gases onboard the vessel. Additionally, the separated water can be removed from the system and can be used as process water onboard the vessel elsewhere, or can even be emitted to the environment, for example surrounding sea, without polluting the environment.

It is preferred that the CO₂ separation means is in fluid communication with the internal combustion engine for feeding at least a portion of the CO₂ depleted stream to the internal combustion engine. The CO₂ depleted stream regularly contains H₂ and CO, and potentially also an unreacted portion of the reformable fuel fed to the anode of the MCFC. Upon recirculating these gases to the internal combustion engine, more specifically as an inlet stream into the internal combustion engine, the performance of the internal combustion engine may be improved. In particular, the addition of H₂ to the fuel originally fed to the internal combustion engine can improve the combustion properties of the internal combustion engine. In a preferred case the fuel originally fed to the internal combustion engine comprises CH₄. A recycling and adding of H₂ to such CH₄ can particularly improve the combustion properties of the internal combustion engine. Moreover, internal combustion engines onboard vehicles often show a so-called methane slip, i.e., methane originally fed to the internal combustion engine is not fully combusted therein, but leaves the internal combustion engine unreacted. This can reduce the efficiency of the internal combustion engine and can lead to environmental issues when the methane unwantedly exits the overall system. The preferred fluid communication between the CO₂ separation means and the internal combustion engine allows to recycle H₂ contained in the anode outlet stream and later contained in the CO₂ depleted stream to the engine proper of the internal combustion engine. The possibility to thereby add H₂ can improve the combustion of the methane in the internal combustion engine and can consequently help to reduce the methane slip.

In case that the internal combustion engine is a gas turbine, it is preferred that the CO₂ separation means is in fluid communication with a post-firing device of the gas turbine for feeding at least a portion of the CO₂ depleted stream to the post-firing device. Such a configuration allows for an advantageous combustion of unburnt, but combustible fuel components contained in the CO₂ depleted stream with the aid of hot exhaust gas coming from the gas turbine and being fed to the post-firing device. For this, the gas turbine is in fluid communication with the post-firing device for feeding at least a portion of the exhaust gas produced by the gas turbine to the post-firing device.

It is preferred that the CO₂ separation means is in fluid communication with a burner for feeding at least a portion of the CO₂ depleted stream via the burner to the cathode of the molten carbonate fuel cell. The burner is a device which can burn combustible components of a fuel or fluid fed to this device. The CO₂ depleted stream may contain H₂ and CO, and in addition also unreacted reformable fuel originally fed to the anode of the MCFC, which will typically comprise CH₄. These gases can be used to feed the separate burner, which can generate additional heat. The additional heat can be utilized onboard the vessel and in particular within the carbon capture system itself, for example for heating the MCFC. The provision of a burner in fluid communication with the CO₂ separation means may thus add to the self-supporting characteristics of the carbon capture system. The provision of a burner in fluid communication with the CO₂ separation means may also help to reduce a methane slip of the internal combustion engine.

It is preferred that the CO₂ separation means is in fluid communication with a hydrogen purification unit, preferably a membrane unit, for receiving at least a portion of the CO₂ depleted stream and for recovering hydrogen therefrom by the hydrogen purification unit. A hydrogen purification unit can thus also be termed an H₂ separation means. It is preferred that the membrane unit comprises a palladium membrane, a carbon membrane, a polymeric membrane, or an inorganic membrane. A preferred membrane unit comprises an inorganic membrane, in particular a metal-based membrane or a ceramic membrane (see for example, S. Adhikari and S. Fernando, Ind. Eng. Chem. Res. Vol. 45, (2006), 875-881). The recovered hydrogen may be sent to an auxiliary fuel cell onboard the vessel for producing additional electric energy, and/or may be used to generate heat, for example by using it in a boiler (a device which can make components of a liquid boil under a given pressure). The additional electric energy and/or heat can be utilized onboard the vessel and in particular within the carbon capture system itself, for example for heating the MCFC. The provision of a hydrogen purification unit in fluid communication with the CO₂ separation means may thus add to the self-supporting characteristics of the carbon capture system. Additionally, or alternatively, the hydrogen may be used in subsequent chemical reactions onboard the vessel, thereby enhancing the versatility of the vessel. Additionally, or alternatively, the hydrogen may be stored onboard the vessel for later onshore utilization thereof.

It is preferred that the CO₂ separation means is in fluid communication with a steam generator for feeding at least a portion of the CO₂ depleted stream to the steam generator for generating steam. As the CO₂ depleted stream regularly contains H₂, CO and CH₄, it can be used to generate heat which in turn can be used to generate steam. The generated steam can be utilized onboard the vessel and in particular within the carbon capture system itself, for example by feeding the steam to the anode of the MCFC for initiating the required reforming reaction at the anode. The provision of a steam generator in fluid communication with the CO₂ separation means may thus add to the self-supporting characteristics of the carbon capture system.

It is preferred that the carbon capture system further comprises a (first) splitter which is in fluid communication with the internal combustion engine for splitting the exhaust gas and controlling an amount of the exhaust gas that is sent to the cathode, and/or further comprises a (second) splitter which is in fluid communication with the CO₂ separation means for controlling an amount of the CO₂ depleted stream which is recycled to the anode and/or the cathode. The first splitter may allow to control the CO₂ flow of the CO₂ rich exhaust gas stream which is sent to the cathode of the MCFC as an inlet stream thereof. The control by the first splitter may advantageously be used to control the power outlet of the MCFC, i.e., the output of electric energy of the MCFC. The first splitter may thus allow to better control the overall carbon capture system. The second splitter may control an amount of the CO₂ depleted stream which is recycled to the cathode and/or to the anode of the MCFC. For this, the second splitter is in fluid communication with the anode and/or the cathode. The control by the second splitter may for example be responsive to concentrations of gases different from CO₂ in the CO₂ depleted stream. The second splitter may thus allow to actively support the reactions occurring at the cathode and/or the anode and may thus enhance the versatility of the overall carbon capture system.

It is preferred that the carbon capture system further comprises a compressor which is in fluid communication with the anode for receiving and compressing at least a portion of the anode outlet stream and for feeding a resulting compressed anode outlet stream to the CO₂ separation means. As compressed CO₂ requires less cooling for transferring it from the gaseous state into the liquid state, a compression of the anode outlet stream prior to entry into the CO₂ separation means can further enhance the effectiveness of the CO₂ separation means. This may in turn lead to even higher concentrated CO₂ being captured by the CO₂ separation means, which adds to the prevention of a pollution of the environment by that CO₂. In this case, the compressor is logically arranged upstream of the CO₂ separation means. It is further preferred that the MCFC has an electric connection to the compressor for at least partially using the electric energy produced by the MCFC to at least partially operate the compressor. In this case, the MCFC supports both, the compressor upstream the CO₂ separation means and the CO₂ separation means itself by operating them with the electric energy produced by the MCFC.

It is preferred that the carbon capture system further comprises a (nother) compressor which is in fluid communication with the CO₂ separation means. Such a compressor allows for a compression of previously separated CO₂ (separated by the CO₂ separation means) and even for liquifying such separated CO₂ which makes storage of the CO₂ onboard the vessel more economic and efficient. It is further preferred that the MCFC has an electric connection to this (other) compressor for at least partially using the electric energy produced by the MCFC to at least partially operate the compressor. In this case, the MCFC supports both, the compressor downstream the CO₂ separation means and the CO₂ separation means itself by operating them with the electric energy produced by the MCFC. In this context, it is even more preferred that the MCFC has an electric connection with the compressor for partially using the electric energy produced by the MCFC to at least partially operate the compressor. In this way, the electric energy is advantageously used onboard the vessel itself and CO₂ may be captured in a particularly effective manner. Moreover, by configuring the carbon capture system in this way, the need for further electricity input from the outside can be reduced and potentially fully removed. Accordingly, the carbon capture system can advantageously become an at least partially self-supporting system.

It is particularly preferred that the MCFC has an electric connection with the CO₂ separation means for at least partially using the electric energy produced by the MCFC to at least partially operate the CO₂ separation means, and that the MCFC additionally has an electric connection with the compressor for partially using the electric energy produced by the MCFC to at least partially operate the compressor. In this way, the electric energy produced by the MCFC is advantageously used onboard the vessel itself twofold, and CO₂ may be captured in an even more effective manner. Moreover, by configuring the carbon capture system in this way, the need for further electricity input from the outside can be further reduced and potentially fully removed. Accordingly, the carbon capture system can at least partially become a particularly self-supporting system.

It is preferred that the carbon capture system further comprises a water-gas-shift reactor which is in fluid communication with the molten carbonate fuel cell for receiving at least a portion of the anode outlet stream. The anode outlet stream may still contain CO and H₂O. The water-gas-shift reactor can convert the CO and the H₂O into CO₂ and H₂. In the subsequent CO₂ separation means, additional CO₂ may thus be captured when producing the CO₂ rich stream, which further helps to avoid a pollution of the environment by CO and CO₂, respectively. Further, the produced CO₂ depleted stream may then contain additional hydrogen, which can be utilized onboard the vessel and in particular in the carbon capture system itself as described above, thereby further helping the carbon capture system to become an at least partially self-supporting system.

Subject of the invention is also a vessel comprising a carbon capture system according to invention. The preferred embodiments of the inventive carbon capture system described herein including the claims are likewise preferred for this inventive vessel in an analogous manner. With such a vessel, it may be possible to capture highly concentrated CO₂ onboard the vessel itself, thereby preventing a pollution of the environment by that CO₂. Additionally, gases of an exhaust gas generated on such a vessel, which are different from CO₂, may be utilized onboard the vessel itself.

Subject of the invention is also a use of a carbon capture system according to the invention for capturing CO₂. The preferred embodiments of the inventive carbon capture system described herein including the claims are likewise preferred for this inventive use in an analogous manner. With such a use, it may be possible to capture highly concentrated CO₂ onboard the vessel itself, thereby preventing a pollution of the environment by that CO₂.

Subject of the invention is also a use of an internal combustion engine and/or a molten carbonate fuel cell and/or a CO₂ separation means in a carbon capture system according to the invention. The preferred embodiments of the inventive carbon capture system described herein including the claims are likewise preferred for this inventive use in an analogous manner. With such a use, it may be possible to realize a carbon capture system onboard a vessel which can capture highly concentrated CO₂ onboard the vessel itself, thereby preventing a pollution of the environment by that CO₂, and which can allow for a utilization of gases different from CO₂ onboard the vessel itself.

Subject of the invention is also a method of capturing CO₂ onboard a vessel, comprising:
feeding a fuel to an internal combustion engine to produce power and an exhaust gas,
feeding at least a portion of the exhaust gas to a cathode of a molten carbonate fuel cell,
operating the molten carbonate fuel cell to produce electric energy,
feeding at least a portion of an anode outlet stream of the molten carbonate fuel cell to a CO₂ separation means,
feeding at least a portion of the electric energy to the CO₂ separation means, and
separating CO₂ from the at least a portion of the anode outlet stream by the CO₂ separation means to produce a CO₂ rich stream and a CO₂ depleted stream.

The preferred embodiments of the inventive carbon capture system described herein including the claims are likewise preferred for this inventive method in an analogous manner. With such a method, it may be possible to capture highly concentrated CO₂ onboard the vessel itself, thereby preventing a pollution of the environment by that CO₂.

Additionally, gases of the exhaust gas, which are different from CO₂, may be utilized onboard the vessel itself.

Subject of the invention is also CO₂ captured with a system according to the invention, or captured on a vessel according to the invention, or captured by a use according to the invention, or captured with a method according to the invention. The preferred embodiments of the inventive carbon capture system described herein including the claims are likewise preferred for this inventive CO₂ in an analogous manner. Such CO₂ is particularly pure because previously accompanying gases are at least partially separated therefrom, which gases may be utilized individually elsewhere. Further, emission of such captured CO₂ into the atmosphere can be prevented, thereby helping to avoid a pollution of the environment.

### BRIEF DESCRIPTION OF THE DRAWINGS

FIG. 1 shows a carbon capture system according to the invention which comprises an internal combustion engine, an MCFC and a CO₂ separation means.

FIG. 2 shows a carbon capture system according to the invention in which the molten carbonate fuel cell has an electric connection with the CO₂ separation means.

FIG. 3 shows a carbon capture system according to the invention in which the CO₂ separation means is in fluid communication with the internal combustion engine.

FIG. 4 shows a carbon capture system according to the invention which comprises a burner in fluid communication with the CO₂ separation means and in fluid communication with the cathode of the MCFC.

FIG. 5 shows a carbon capture system according to the invention which comprises a hydrogen purification unit in fluid communication with the CO₂ separation means.

FIG. 6 shows a carbon capture system according to the invention which comprises a steam generator in fluid communication with the CO₂ separation means.

FIG. 7 shows a carbon capture system according to the invention which comprises a first splitter in fluid communication with the internal combustion engine and a second splitter in fluid communication with the CO₂ separation means.

FIG. 8 shows a carbon capture system according to the invention which comprises a compressor in fluid communication with the anode of the MCFC.

FIG. 9 shows a carbon capture system according to the invention which comprises a water-gas-shift reactor in fluid communication with the anode of the MCFC.

FIG. 10 shows a carbon capture system according to the invention in which the CO₂ separation means is in additional fluid communication with the anode of the MCFC.

FIG. 11 shows a carbon capture system according to the invention which comprises a compressor in fluid communication with the anode of the MCFC and in which the CO₂ separation means is in additional fluid communication with the anode of the MCFC.

FIG. 12 shows a carbon capture system according to the invention which comprises a compressor in fluid communication with the CO₂ separation means.

### EXEMPLARY EMBODIMENTS

The present invention is further described with reference to the accompanying figures. The present invention is directed to a carbon capture system 1 which is located on a vessel, i.e., which is a carbon capture system 1 onboard a vessel. The vessel itself is however not shown in the figures. Where arrows are used, the rectangular end represents the “upstream” side or position, while the arrow end represents the “downstream” side or position.

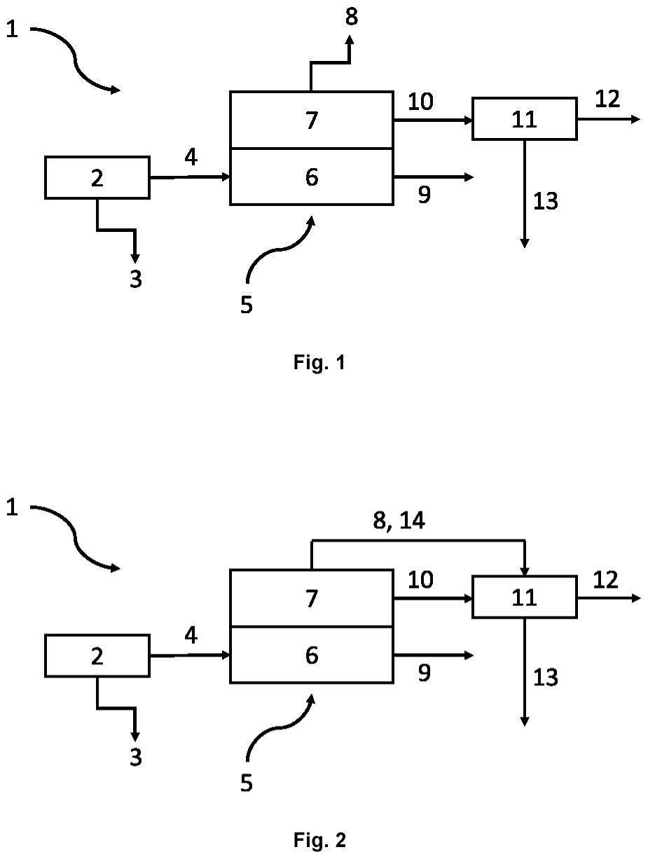

An exemplary embodiment of a carbon capture system 1 is shown in FIG. 1. The carbon capture system 1 comprises an internal combustion engine 2 for producing power 3 and an exhaust gas 4. The internal combustion engine 2 is preferably a Diesel engine, an Otto engine or a gas turbine. The internal combustion engine 2 is fed with a fuel which comprises hydrocarbons, typically including methane, for combustion in the engine proper of the combustion engines (not shown). By combusting the fuel, the internal combustion engine 2 produces the power 3 and the exhaust gas 4. The power 3 produced by the internal combustion engine 2 is typically used for propelling the vessel in which the carbon capture system 1 is installed, but may also be used for other applications. The exhaust gas 4 produced by the internal combustion engine 2 typically contains carbon-based fuel waste such as carbon oxides, nitrogen oxides and sulfur oxides. The exhaust gas 4 typically contains carbon dioxide (CO₂), and the present invention aims at capturing and potentially using CO₂ onboard the vessel in order to avoid an emission of the CO₂ to the atmosphere, thereby preventing a pollution of the environment by such emitted CO₂. In order to further concentrate the CO₂, the carbon capture system 1 further comprises an MCFC 5 downstream of the internal combustion engine 2. The MCFC comprises two electrodes, namely a cathode 6 and an anode 7. In the embodiment of FIG. 1, both these electrodes are made of nickel. The MCFC 5 further comprises an electrolyte between the two electrodes. In the embodiment of FIG. 1, the electrolyte is a blend of Li₂CO₃ and K₂CO₃. The MCFC 5 is preferably operated at a temperature in the range of 540 to 750° C., more preferably in the range of 550 to 700° C., and still more preferably in the range of 580° C. to 675° C. The MCFC 5 is further operated such that it generates electricity, i.e., the MCFC 5 produces electric energy 8. A resulting typical cell voltage is about 0.7 V. The exhaust gas 4 is used as an inlet stream for the MCFC 5 and is more specifically sent to the cathode 6 of the MCFC 5 (the cathode inlet stream). This cathode inlet stream typically has a high CO₂ concentration. At the same time a fuel comprising methane is used as a further inlet stream for the MCFC 5 and is more specifically sent to the anode 7 of the MCFC 5 (the anode inlet stream). During the operation of the MCFC 5, CO₂ is transferred from the cathode 6 to the anode 7. As a result, the cathode outlet stream 9 has a lower CO₂ concentration than the cathode inlet stream, while the anode outlet stream 10 has a higher CO₂ concentration than the anode inlet stream. The anode outlet stream 10 is subsequently sent to another unit for separating CO₂ from that anode outlet stream 10. This can also be seen as a further purification of the CO₂ exiting the anode 7 in order to provide a purified CO₂ stream for subsequent storage or further use. The unit for separating CO₂ from that anode outlet stream 10, or for purifying this CO₂ outlet stream, is combinedly referred to herein as a “CO₂ separation means”. In the embodiment of FIG. 1, the CO₂ separation means 11 is a low temperature phase change separation unit which liquifies CO₂ contained in the anode outlet stream 10 and allows to separate liquified CO₂ therefrom. In the embodiment of FIG. 1, this low temperature phase change separation unit is operated under typical conditions of a temperature of −53 to −56° C. and an absolute pressure of 1 to 2 MPa, for example −55° C. and 2 MPa. The CO₂ separation means 11 thereby produces a basically liquid CO₂ rich stream 12 and a basically gaseous CO₂ depleted stream 13. In the embodiment of FIG. 1, a purity of the CO₂ rich stream 12 of at least 95 mol % is achieved. Further, compared to the originally produced exhaust gas 4, the carbon capture system 1 of FIG. 1 achieves an avoidance rate of CO₂ emission of at least 80 wt. %, i.e., at most 20 wt. % of the CO₂ produced by the internal combustion engine 2 are emitted to the atmosphere. The carbon capture system 1 of FIG. 1 may further achieve an avoidance rate of CO₂ emission of at least 90 wt. % and even up to 100 wt. %. The carbon capture system 1 of FIG. 1 can thereby prevent a respective pollution of the environment. In the embodiment of FIG. 1, the captured CO₂ is sent to one or more not shown containers for onboard storage of the CO₂. For this, the CO₂ separation means 11 is in fluid communication with the one or more containers. In an unshown alternative, the captured CO₂ is further used onboard the vessel, in particular as a cathode feed for a second, auxiliary molten carbonate fuel cell onboard which produces additional electric energy.

FIG. 2 shows a supplementing exemplary embodiment of a carbon capture system 1 in which the electric energy 8 is used for operating the CO₂ separation means 11, in particular a low temperature phase change separation unit. This is realized by the electric connection 14 of the MCFC 5 with the CO₂ separation means 11, established by wiring. In order to achieve the typical conditions of the low temperature phase change separation unit of a temperature of −53 to −56° C. and an absolute pressure of 1 to 2 MPa, especially −55° C./2 MPa, simultaneous cooling and pressurising is required. Such cooling and pressurising typically requires electric energy, for example for circulating a cooling fluid or moving a pressure exerting element. For this purpose, the CO₂ separation means 11 of FIG. 2 uses the electric energy produced by the MCFC 5. There is thus no (or reduced) need to feed additional electric energy from the outside to the carbon capture system 1. The carbon capture system 1 thereby advantageously becomes a self-supporting system. Even if not shown, an electric connection 14 of the MCFC 5 with the CO₂ separation means 11 can additionally and analogously be a feature of the carbon capture system 1 according to any of FIGS. 1 and 3 to 9.

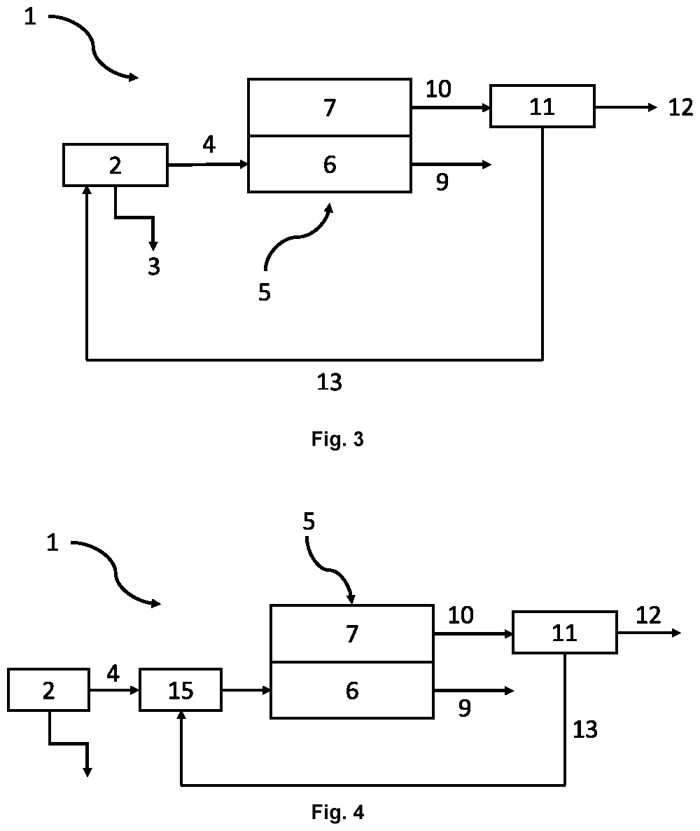

FIG. 3 shows a supplementing exemplary embodiment of a carbon capture system 1 in which the CO₂ depleted stream 13 is recirculated to the internal combustion engine 2. In a first case, the internal combustion engine 2 of FIG. 3 is a volumetric engine, in particular a Diesel engine or an Otto engine. In this case, the CO₂ depleted stream 13 becomes an additional inlet stream for the internal combustion engine. The CO₂ depleted stream 13 typically contains H₂ and/or CO, which is mixed with the fuel fed to the internal combustion engine 2. The combustion reactions occurring within the internal combustion engine 2 thereby become more complete, so that the efficiency of the combustion reactions is improved and less methane contained in the fuel slips unreacted (or unburnt) through the internal combustion engine 2. Accordingly, the combustion properties of the internal combustion engine 2 of the carbon capture system according to FIG. 3 are improved, and simultaneously the methane slip occurring in the system is reduced. In a second case the internal combustion engine 2 of FIG. 3 is a gas turbine. In this case, the CO₂ separation means is more specifically in fluid communication with a post-firing device of the gas turbine (not shown). The post-firing device is in fluid communication with the gas turbine and receives exhaust gas produced by the gas turbine. In this scenario, the CO₂ depleted stream 13 is more specifically sent to the post-firing device. Valuable components of the CO₂ depleted stream 13, in particular H₂, CO and/or unburnt CH₄, are thereby recycled and mixed with the exhaust gas produced by the gas turbine. The combustion reactions occurring in the post-firing device thereby become more complete and thus more efficient. Accordingly, the combustion properties of the post-firing device and hence of the overall internal combustion engine 2 are also improved in this scenario. Although not shown, a recirculation of the CO₂ depleted stream 13 to the internal combustion engine 2 can additionally and analogously be a feature of the carbon capture system 1 according to any of FIGS. 1, 2 and 4 to 9.

FIG. 4 shows a supplementing exemplary embodiment of a carbon capture system 1 in which the CO₂ depleted stream 13 is recirculated to the cathode 6 of the MCFC 5 via a burner 15. Additionally, the burner 15 receives at least a part of the exhaust gas 4 (in FIG. 4, all exhaust gas 4 is sent to the burner 15; alternatively, exhaust gas 4 may be split to be partly fed to the burner 15 and partly directly to cathode 6). The exhaust gas 4 regularly contains some air which is the used for an oxidisation in the burner 15. The burner 15 is thus a device which allows for an oxidisation of gases in the CO₂ depleted stream 13 which are different from CO₂, for example residual hydrocarbons, especially CH₄, and/or H₂ and/or CO. By burning these gases, the burner 15 increases the CO₂ concentration in the CO₂ depleted stream 13 which is thereafter sent to the cathode 6. Accordingly, the cathode inlet stream will have an even higher CO₂ concentration, thereby rendering the electric energy producing reactions in the MCFC 5 more effective, which adds to the self-supporting properties of carbon capture system 1. At the same time, the burner 15 generates additional heat which can be used onboard the vessel and in particular within the carbon capture system 1 itself. For example, the MCFC 5 requires elevated temperatures for its operation due to the need of a molten carbonate electrolyte. The heat generated by the burner 15 can be used to heat up the MCFC 5 as required, which further adds to the self-supporting properties of carbon capture system 1. Additionally, by burning residual CH₄, the burner 15 contributes to an overall reduction of potential methane slip of the internal combustion engine 2, and the burner 15 further increases the CO₂ concentration in the stream sent to the cathode 6. Although not shown, a burner 15 including a recirculation of the CO₂ depleted stream 13 to the cathode 6 of the MCFC 5 can additionally and analogously be a feature of the carbon capture system 1 according to any of FIGS. 1 to 3 and 5 to 9.

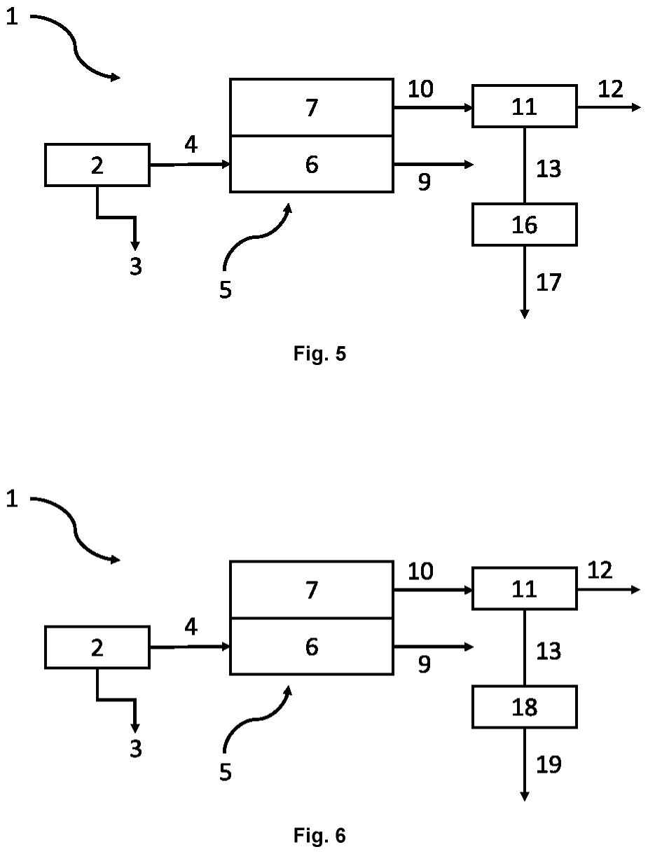

FIG. 5 shows a supplementing exemplary embodiment of a carbon capture system 1 which comprises a hydrogen purification unit 16 which is in fluid communication with the CO₂ separation means 11. In the embodiment of FIG. 5, the hydrogen purification unit 16 is a ceramic membrane unit (alternatives are a palladium membrane unit, a carbon membrane unit, and a polymeric membrane unit), which separates hydrogen 19 contained in the CO₂ depleted stream 13. The separated hydrogen 19 is then preferably sent to an auxiliary fuel cell onboard the vessel as an anode inlet stream for this auxiliary fuel cell (not shown). The auxiliary fuel cell produces additional electric energy which can be used to operate different means, devices, units, etc. of the carbon capture system 1 and which can in particular be used to operate the CO₂ separation means 11. The hydrogen purification unit 16 used in the system of FIG. 5 thereby fosters the self-supporting properties of carbon capture system 1. Although not shown, a hydrogen purification unit 16 can additionally and analogously be a feature of the carbon capture system 1 according to any of FIGS. 1 to 4 and 6 to 9.

FIG. 6 shows a supplementing exemplary embodiment of a carbon capture system 1 which comprises a steam generator 18 which is in fluid communication with the CO₂ separation means 11. Like the burner 15, the steam generator 18 makes use of residual components in the CO₂ depleted stream 13, in particular of yet unreacted (unburnt) hydrocarbons, especially CH₄, and/or H₂ and/or CO in a further oxidation process which generates heat. For the oxidation process, additional air is regularly fed to the steam generator 18 (not shown). The generated heat actually heats up water to produce steam. The steam can especially be used as an additional inlet stream of anode 7 of the MCFC 5 to initiate a reforming reaction like CH₄+H₂O=3H₂+CO. The steam generator 18 used in the carbon capture system 1 of FIG. 6 thereby fosters the self-supporting properties of that carbon capture system 1. Although not shown, a steam generator 18 can additionally and analogously be a feature of the carbon capture system 1 according to any of FIGS. 1 to 5 and 7 to 9.

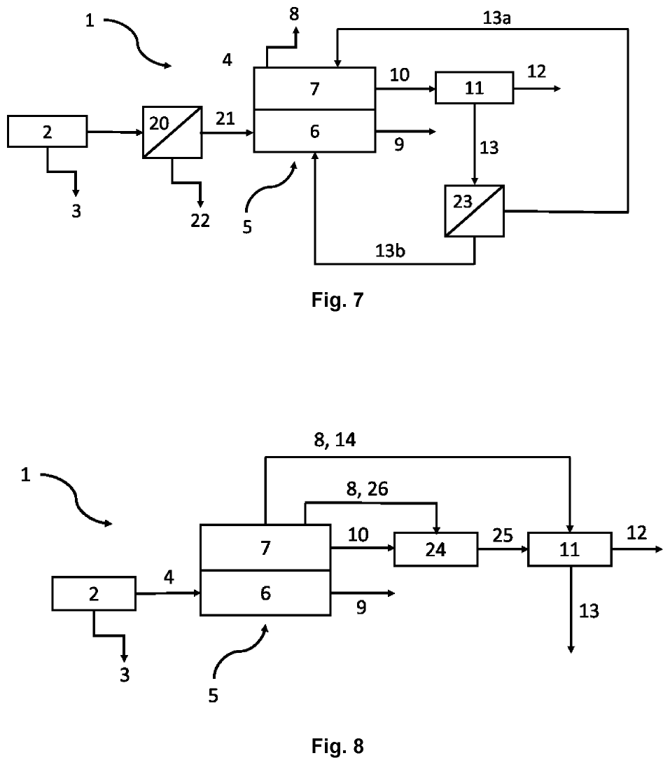

FIG. 7 shows a supplementing exemplary embodiment of a carbon capture system 1 which comprises a first splitter 20 in fluid communication with the internal combustion engine 2. The first splitter 20 splits the exhaust gas 4 into two different streams, a first split stream 21 and a second split stream 22. Accordingly, the flow of exhaust gas from the internal combustion engine 2 is controlled by the splitter 20. A controlled portion of the exhaust gas 4 is thereby brought into contact with the cathode 6 at which CO₂ is selectively extracted according to the electrochemical reactions described herein. That is, the flowrate of the first split stream 21 is controlled. The first split stream 21 corresponds to the amount of the exhaust gas 4 that is sent to the cathode. The control of the flowrate of the first split stream 21 is used to control the electric output of MCFC 5, i.e., to control the electric energy produced by MCFC 5. The use of the produced electric energy within the carbon capture system 1 itself is then controlled according to demand for such energy within the system. The first splitter 20 used in the carbon capture system 1 of FIG. 7 thereby fosters the self-supporting properties of that carbon capture system 1. The carbon capture system 1 of FIG. 7 further comprises a second splitter 23 which is in fluid communication with the CO₂ separation means. The second splitter 23 splits the CO₂ depleted stream 13 into two streams which are sent to the cathode 6 and the anode 7, i.e., they are recycled to the cathode 6 and/or to the anode 7 as CO₂ depleted partial stream 13a and CO₂ depleted partial stream 13b. In the embodiment of FIG. 7, the second splitter 23 controls the split between the two recycled streams in response to the concentration of CH₄ in the CO₂ depleted stream 13. By setting the split between the two recycled streams accordingly, the second splitter 23 controls the power outlet of the MCFC 5. The second splitter 23 used in the carbon capture system 1 of FIG. 7 thereby also fosters the self-supporting properties of that carbon capture system 1 and enhances the versatility thereof. Although not shown, a carbon capture system 1 of FIG. 7 comprising only one of splitter 20 or splitter 23 is also disclosed herein. Although not shown, a splitter 20 and/or a splitter 23 can additionally and analogously be a feature of the carbon capture system 1 according to any of FIGS. 1 to 6, 8 and 9.

FIG. 8 shows a supplementing exemplary embodiment of a carbon capture system 1 which further comprises a compressor 24 in fluid communication with the anode 7. The compressor 24 receives the anode outlet stream 10 and subsequently compresses the received anode outlet stream 10. The result of the compression is the compressed anode outlet stream 25, which is sent to the CO₂ separation means 11, which is a low temperature phase change separation unit as in the embodiment of FIG. 1. The low temperature phase change separation unit can now work under reduced pressure compared to the embodiment of FIG. 1 because the received stream is here the compressed anode outlet stream 25. Hence, less additional compression work has to be invested by the CO₂ separation means 11 in order to liquify the CO₂. As the received stream is pre-compressed, the separation of CO₂ within the CO₂ separation means 11 can occur quicker and more efficiently. The CO₂ captured with the carbon capture system 1 of FIG. 8 may consequently have an even higher concentration than the CO₂ captured by the carbon capture system 1 of FIG. 1. The carbon capture system 1 of FIG. 8 thereby effectively prevents a pollution of the environment by the CO₂ thus captured. Further, in the carbon capture system 1 of FIG. 8, the MCFC 5 has an electric connection 26 (wiring) with the compressor 24. The electric energy 8 produced by the MCFC 5 is partially used to operate the compressor 24. No (or less) electricity input from the outside is thus required for operating the compressor 24. The electric connection 26 between MCFC 5 and compressor 24 therefore contributes to the self-supporting characteristics of the carbon capture system 1. Additionally, in the carbon capture system 1 of FIG. 8, the MCFC 5 has an electric connection 14 (wiring) with the CO₂ separation means 11. No (or less) electricity input from the outside is thus required for operating the compressor 24. The electric connection 14 between MCFC 5 and CO₂ separation means 11 therefore contributes to the self-supporting characteristics of the carbon capture system 1. Although not shown, a carbon capture system 1 of FIG. 7 comprising only one of electric connection 26 or electric connection 14 is also disclosed herein. Similarly, while also not shown, a carbon capture system 1 of FIG. 7 comprising neither electric connection 26 nor electric connection 14 is also disclosed herein. Further, although not shown, a compressor 24 and/or an electric connection 26 and/or an electric connection 14 can additionally and analogously be a feature of the carbon capture system 1 according to any of FIGS. 1 to 7 and 9.

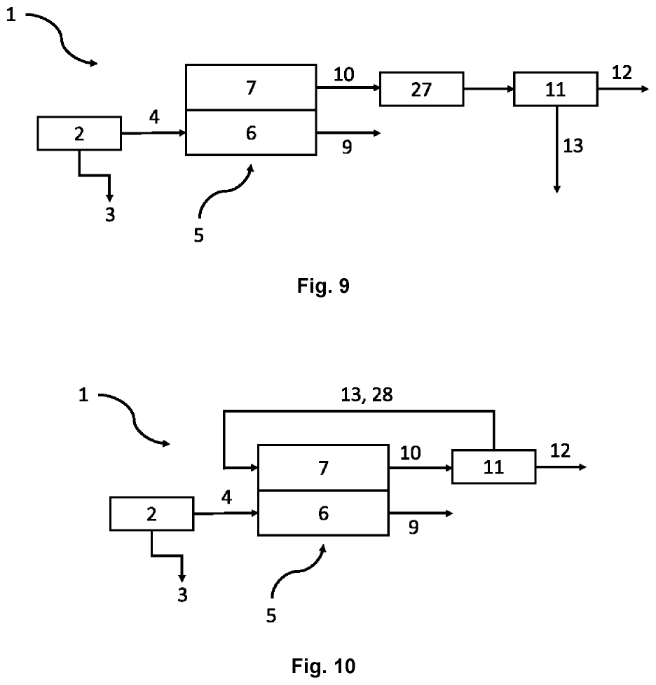

FIG. 9 shows a supplementing exemplary embodiment of a carbon capture system 1 which comprises a water-gas-shift reactor 27 in fluid communication with the molten carbonate fuel cell 5. The water-gas-shift reactor 27 receives the anode outlet stream 10 which typically contains residual CO and H₂O. The water-gas-shift reactor converts the CO and the H₂O into CO₂ and H₂. The converted stream is then sent to the CO₂ separation means 11, which can capture the additional CO₂ produced by the water-gas-shift reactor. The additionally captured CO₂ is thereby also prevented from polluting the environment. Although not shown, a water-gas-shift reactor 27 can additionally and analogously be a feature of the carbon capture system 1 according to any of FIGS. 1 to 8.

FIG. 10 shows a supplementing exemplary embodiment of a carbon capture system 1 in which the CO₂ separation means 11 has an additional (or second) fluid communication with the anode 7. Via this additional fluid communication, the CO₂ depleted stream 13 is recycled to the anode 7 and thereby becomes an anode inlet stream 28. Of course, the anode is further fed with some fuel so that there is at least one further anode inlet stream (not shown). Although in FIG. 10 the entire CO₂ depleted stream 13 is recycled to the anode 7, it is also contemplated that the CO₂ depleted stream 13 is only partially recycled to the anode 7. By recycling, or returning, at least a part of the CO₂ depleted stream 13 to the anode 7 unreacted components of the reformable fuel sent to the anode 7 are recirculated within the system. Accordingly, these regularly valuable components are not lost, but are utilized in an improved manner, making the overall system more economic.

FIG. 11 shows a supplementing exemplary embodiment of a carbon capture system 1 which is basically a combination of the exemplary embodiments of FIGS. 8 and 10. That is, in this embodiment the carbon capture system 1 further comprises a compressor 24 in fluid communication with the anode 7. Additionally, the CO₂ separation means 11 has an additional (or second) fluid communication with the anode 7. The same elements as described separately for FIG. 8 and for FIG. 10 above are jointly present in this embodiment and lead to the same effects. Accordingly, the MCFC 5 produces electric energy 8 which is used to operate both, the CO₂ separation means 11 and the compressor 24. The compressor 24 supports the CO₂ separation means 11 in that pre-compressed CO₂ is sent to the CO₂ separation means 11 where the CO₂ separation can occur quicker and more efficiently. The CO₂ separation means 11 at least partially recirculates the CO₂ depleted stream 13 to the anode 7, wherein the CO₂ depleted stream 13 contains unreacted and hence still usable fuel components. Accordingly, the CO₂ separation means 11 supports the MCFC 5. It is thus seen that the MCFC 5, the CO₂ separation means 11 and the compressor 24 mutually support each other, thereby adding to the self-supporting characteristics of the carbon capture system 1.

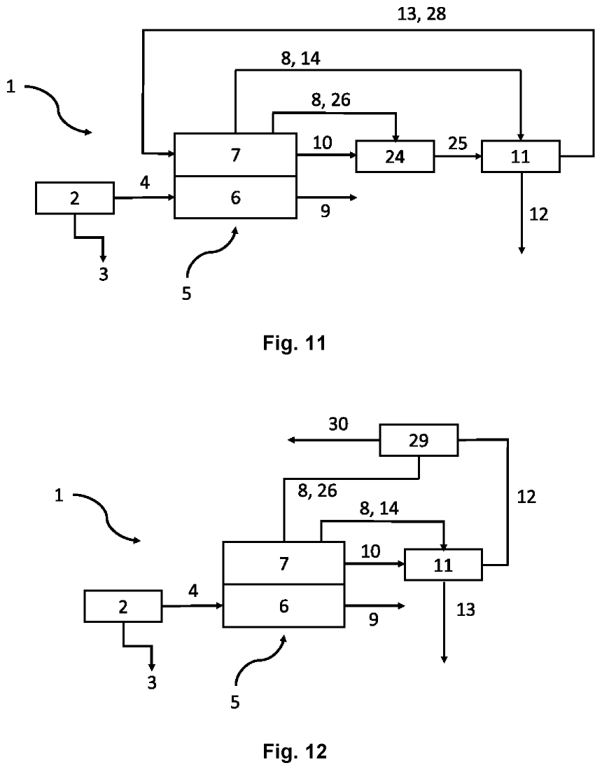

FIG. 12 shows a supplementing exemplary embodiment of a carbon capture system 1 In this embodiment the carbon capture system 1 further comprises a (nother) compressor 29 in fluid communication with the CO₂ separation means 11. Here, the MCFC 5 produces electric energy 8 which is used to operate both, the CO₂ separation means 11 and the further compressor 29. The compressor 29 receives a CO₂ rich stream 12 from the CO₂ separation means 11 and compresses the received CO₂ such that the CO₂ is liquified and can subsequently be conveniently stored onboard the vessel.

### LIST OF REFERENCE SIGNS

1: carbon capture system
2: internal combustion engine
3: power
4: exhaust gas
5: molten carbonate fuel cell
6: cathode
7: anode
8: electric energy
9: cathode outlet stream
10: anode outlet stream
11: CO₂ separation means
12: CO₂ rich stream
13: CO₂ depleted stream
13a: CO₂ depleted partial stream
13b: CO₂ depleted partial stream
14: electric connection
15: burner
16: hydrogen purification unit
17: hydrogen
18: steam generator
19: steam
20: splitter
21: first split stream
22: second split stream
23: splitter
24: compressor
25: compressed anode outlet stream
26: electric connection
27: water-gas-shift reactor
28: anode inlet stream
29: a (nother) compressor
30: compressed CO₂ rich stream

### FURTHER DISCLOSURE

The present invention further provides the following items:

1. A carbon capture system (1) onboard a vessel, comprising:
an internal combustion engine (2) for producing power (3) and an exhaust gas (4),
a molten carbonate fuel cell (5), which comprises a cathode (6) and an anode (7), for producing electric energy (8), a cathode outlet stream (9) and an anode outlet stream (10), wherein the cathode (6) is in fluid communication with the internal combustion engine (2) for receiving at least a portion of the exhaust gas (4), and
a CO₂ separation means (11) which is in fluid communication with the anode (7) for receiving at least a portion of the anode outlet stream (10), wherein the CO₂ separation means (11) is configured to separate CO₂ from the at least a portion of the anode outlet stream (10) for producing a CO₂ rich stream (12) and a CO₂ depleted stream (13).

2. The system (1) according to item 1, wherein the molten carbonate fuel cell (5) has an electric connection (14) with the CO₂ separation means (11) for at least partially using the electric energy (8) to at least partially operate the CO₂ separation means (11).

3. The system (1) according to item 1 or 2, wherein the CO₂ separation means (11) is a low temperature separation unit which is additionally configured to separate water from the at least a portion of the anode outlet stream (10).

4. The system (1) according to any of the preceding items, wherein the CO₂ separation means (11) is in fluid communication with the internal combustion engine (2) for feeding at least a portion of the CO₂ depleted stream (13) to the internal combustion engine (2).

5. The system (1) according to any of the preceding item, wherein the CO₂ separation means (11) is in fluid communication with a burner (15) for feeding at least a portion of the CO₂ depleted stream (13) via the burner (15) to the cathode (6) of the molten carbonate fuel cell (5).

6. The system (1) according to any of the preceding items, wherein the CO₂ separation means (11) is in fluid communication with a hydrogen purification unit (16), preferably a membrane unit, for receiving at least a portion of the CO₂ depleted stream (13) and for recovering hydrogen (17) therefrom by the hydrogen purification unit.

7. The system (1) according to any of the preceding items, wherein the CO₂ separation means (11) is in fluid communication with a steam generator (18) for feeding at least a portion of the CO₂ depleted stream (13) to the steam generator (18) for generating steam (19).

8. The system (1) according to any of the preceding items, further comprising a splitter (20) which is in fluid communication with the internal combustion engine (2) for splitting the exhaust gas (3) and controlling an amount of the exhaust gas (4) that is sent to the cathode, and/or further comprising a splitter (23) which is in fluid communication with the CO₂ separation means (11) for controlling an amount of the CO₂ depleted stream (13) which is recycled to the cathode (6) and/or to the anode (7).

9. The system (1) according to any of the preceding items, further comprising a compressor (24) which is in fluid communication with the anode (7) for receiving and compressing at least a portion of the anode outlet stream (10) and for feeding a resulting compressed anode outlet stream (25) to the CO₂ separation means (11), wherein the molten carbonate fuel cell (5) preferably has an electric connection (26) with the compressor (24) for partially using the electric energy (8) to at least partially operate the compressor (24).

10. The system (1) according to any of the preceding items, further comprising a water-gas-shift reactor (27) which is in fluid communication with the anode (7) for receiving at least a portion of the anode outlet stream (10).

11. A vessel comprising a carbon capture system (1) according to any of items 1 to 10.

12. Use of a carbon capture system (1) according to any of items 1 to 10 for capturing CO₂.

13. Use of an internal combustion engine (2) and/or a molten carbonate fuel cell (5) and/or a CO₂ separation means (11) in a carbon capture system (1) according to any of items 1 to 10.

14. A method of capturing CO₂ onboard a vessel, comprising:
feeding a fuel to an internal combustion engine (2) to produce power (3) and an exhaust gas (4),
feeding at least a portion of the exhaust gas (4) to a cathode (6) of a molten carbonate fuel cell (5),
operating the molten carbonate fuel cell (5) to produce electric energy (8),
feeding at least a portion of an anode outlet stream (10) of the molten carbonate fuel cell (5) to a CO₂ separation means (11), and
separating CO₂ from the at least a portion of the anode outlet stream (10) by the CO₂ separation means (11) to produce a CO₂ rich stream (12) and a CO₂ depleted stream (13).

15. CO₂ captured with a carbon capture system (1) according to any of items 1 to 10, or captured on a vessel according to item 11, or captured by the use according to item 12, or captured with a method according to item 14.

1. A carbon capture system (1) onboard a vessel, comprising:
an internal combustion engine (2) for producing power (3) and an exhaust gas (4),
a molten carbonate fuel cell (5), which comprises a cathode (6) and an anode (7), for producing electric energy (8), a cathode outlet stream (9) and an anode outlet stream (10), wherein the cathode (6) is in fluid communication with the internal combustion engine (2) for receiving at least a portion of the exhaust gas (4), and
a CO₂ separation means (11) which is in fluid communication with the anode (7) for receiving at least a portion of the anode outlet stream (10), wherein the CO₂ separation means (11) is configured to separate CO₂ from the at least a portion of the anode outlet stream (10) for producing a CO₂ rich stream (12) and a CO₂ depleted stream (13),
wherein the molten carbonate fuel cell (5) has an electric connection (14) with the CO₂ separation means (11) for at least partially using the electric energy (8) to at least partially operate the CO₂ separation means (11).

2. The system (1) according to claim 1, wherein the CO₂ separation means (11) is in additional fluid communication with the anode (7) for at least partially recycling the CO₂ depleted stream (13) to the anode (7) as an anode inlet stream (28).

3. The system (1) according to claim 1 or 2, wherein the CO₂ separation means (11) is a low temperature separation unit which is additionally configured to separate water from the at least a portion of the anode outlet stream (10).

4. The system (1) according to any of the preceding claims, wherein the CO₂ separation means (11) is in fluid communication with the internal combustion engine (2) for feeding at least a portion of the CO₂ depleted stream (13) to the internal combustion engine (2).

5. The system (1) according to any of the preceding claims, wherein the CO₂ separation means (11) is in fluid communication with a burner (15) for feeding at least a portion of the CO₂ depleted stream (13) via the burner (15) to the cathode (6) of the molten carbonate fuel cell (5).

6. The system (1) according to any of the preceding claims, wherein the CO₂ separation means (11) is in fluid communication with a hydrogen purification unit (16), preferably a membrane unit, for receiving at least a portion of the CO₂ depleted stream (13) and for recovering hydrogen (17) therefrom by the hydrogen purification unit.

7. The system (1) according to any of the preceding claims, wherein the CO₂ separation means (11) is in fluid communication with a steam generator (18) for feeding at least a portion of the CO₂ depleted stream (13) to the steam generator (18) for generating steam (19).

8. The system (1) according to any of the preceding claims, further comprising a splitter (20) which is in fluid communication with the internal combustion engine (2) for splitting the exhaust gas (3) and controlling an amount of the exhaust gas (4) that is sent to the cathode, and/or further comprising a splitter (23) which is in fluid communication with the CO₂ separation means (11) for controlling an amount of the CO₂ depleted stream (13) which is recycled to the cathode (6) and/or to the anode (7).

9. The system (1) according to any of the preceding claims, further comprising a compressor (24) which is in fluid communication with the anode (7) for receiving and compressing at least a portion of the anode outlet stream (10) and for feeding a resulting compressed anode outlet stream (25) to the CO₂ separation means (11), wherein the molten carbonate fuel cell (5) preferably has an electric connection (26) with the compressor (24) for partially using the electric energy (8) to at least partially operate the compressor (24).

10. The system (1) according to any of the preceding claims, further comprising a water-gas-shift reactor (27) which is in fluid communication with the anode (7) for receiving at least a portion of the anode outlet stream (10).

11. A vessel comprising a carbon capture system (1) according to any of claims 1 to 10.

12. Use of a carbon capture system (1) according to any of claims 1 to 10 for capturing CO₂.

13. Use of an internal combustion engine (2) and/or a molten carbonate fuel cell (5) and/or a CO₂ separation means (11) in a carbon capture system (1) according to any of claims 1 to 10.

14. A method of capturing CO₂ onboard a vessel, comprising:
feeding a fuel to an internal combustion engine (2) to produce power (3) and an exhaust gas (4),
feeding at least a portion of the exhaust gas (4) to a cathode (6) of a molten carbonate fuel cell (5),
operating the molten carbonate fuel cell (5) to produce electric energy (8), feeding at least a portion of an anode outlet stream (10) of the molten carbonate fuel cell (5) to a CO₂ separation means (11),
feeding at least a portion of the electric energy (8) to the CO₂ separation means (11), and
separating CO₂ from the at least a portion of the anode outlet stream (10) by the CO₂ separation means (11) to produce a CO₂ rich stream (12) and a CO₂ depleted stream (13).

15. CO₂ captured with a carbon capture system (1) according to any of claims 1 to 10, or captured on a vessel according to claim 11, or captured by the use according to claim 12, or captured with a method according to claim 14.
